(19) United States
(12) Patent Application Publication
(10) Pub. No.: US 2010/0187874 A1
(43) Pub. Date: Jul. 29, 2010

(54) INTERNAL STRUCTURE OF SEATBACK CONNECTED TO ACTIVE HEADREST

(75) Inventor: Kei MATSUI, Toyota-shi (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/648,494

(22) Filed: Dec. 29, 2009

(30) Foreign Application Priority Data
Jan. 27, 2009 (JP) 2009-015322

(51) Int. Cl. B60N 2/427; B60N 2/42; B60N 2/68

(52) U.S. Cl. 297/216.12

(57) ABSTRACT

A seatback includes an active headrest that moves forward to catch the back of the head of an occupant, when a load is applied by the occupant to a seatback in a rear-end collision. A first panel and a second panel are provided between a plurality of frame members that constitute the frame of the seatback. The first panel is flexible, and the second panel is more rigid than the first panel. A pressure-receiving member is attached to the second panel, receives the load applied by the occupant to the seatback through the second panel, and transmits the load applied to the seatback to a lock mechanism in the active headrest.

### INCORPORATION BY REFERENCE

The disclosure of Japanese Patent Application No. 2009-015322 filed on Jan. 27, 2009 including the specification, drawings and abstract is incorporated herein by reference in its entirety.

### BACKGROUND OF THE INVENTION

1. Field of the Invention

The present invention relates to the internal structure of a seatback that is assembled with an active headrest.

2. Description of the Related Art

The related art describes a vehicle seat headrest that moves forward, toward the back of an occupant's head, immediately after the host vehicle is struck in a rear-end collision. Japanese Patent Application Publication No. 2002-345597 (JP-A-2002-345597) describes technology in which the headrest moves forward when a rear-end collision has occurred and an impact load of the vehicle seat occupant that is applied to the seatback is detected. As described above, because the headrest moves forward in a rear-end collision, it is possible to reduce an impact on the back of the occupant's head and thus to increase safety.

However, in the conventional technology described above, a lumbar support plate that receives a load applied by the occupant to the seatback is adopted as a flexible member so as to flexibly support the lumbar region of the occupant. Although a flexible structure improves riding comfort of the occupant, it causes inaccurate detection of the load applied by the occupant to the seatback when the load is absorbed due to its flexibility. Consequently, the headrest may not function appropriately.

### SUMMARY OF THE INVENTION

The present invention provides an internal structure of a seatback that improves riding comfort of an occupant and ensures accurate activation of an active headrest when the seatback is connected to the active headrest.

A first aspect of the present invention is the internal structure of the seatback that is connected to the active headrest that moves forward to catch the back of the occupant's head when a load is applied by the occupant to the seatback in a rear-end collision. In this embodiment, a first panel and a second panel are provided between plural frame members that constitute a framework of the seatback. The first panel is formed to have flexibility and the second panel is formed to be more rigid than the first panel. A pressure-receiving member that is attached to the second panel is also provided. The pressure-receiving member receives the load applied to the seatback through the second panel, and transmits the load applied to the seatback to a lock mechanism in the active headrest. In accordance with this configuration, because the first panel is flexible, it is possible for the seatback to flexibly support the thoracic or lumbar region of the occupant. Therefore, it is possible to improve riding comfort of the occupant. Furthermore, because the second panel is rigid, it is possible to reliably have the pressure-receiving member turned using the load applied by the occupant to the seatback. Accordingly, the active headrest is reliably activated.

In the first embodiment, the first panel and the second panel may be formed of resin. This configuration facilitates high-volume production of both of the panels.

The first panel and the second panel may also be integrally formed. This configuration facilitates the assembly of a panel because only a single panel needs to be assembled.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a schematic diagram that shows an entire vehicle seat that is applied with an internal structure of a seatback that is assembled with an active seatback according to a first embodiment of the present invention and shows a state before panel members are assembled to the seatback;

FIG. 2 shows the vehicle seat of FIG. 1 with the panel members of the seatback in place;

FIG. 3 is a perspective view of an entire clutch mechanism in FIG. 1;

FIG. 4 is a schematic side view of the clutch mechanism in FIG. 1;

FIG. 5 is a schematic front view of the clutch mechanism in FIG. 1;

FIG. 6 is a schematic side view showing an occupant seated on the vehicle seat of FIG. 2;

FIG. 7 is a schematic diagram that shows an entire vehicle seat that is applied with an internal structure of a seatback assembled with an active headrest according to a second embodiment of the present invention and shows a state before panel members are assembled to the seatback;

FIG. 8 shows the vehicle seat of FIG. 7 with the panel members of the seatback in place; and

FIG. 9 is a schematic side view showing the occupant seated on the vehicle seat of FIG. 8.

### DETAILED DESCRIPTION OF EMBODIMENTS

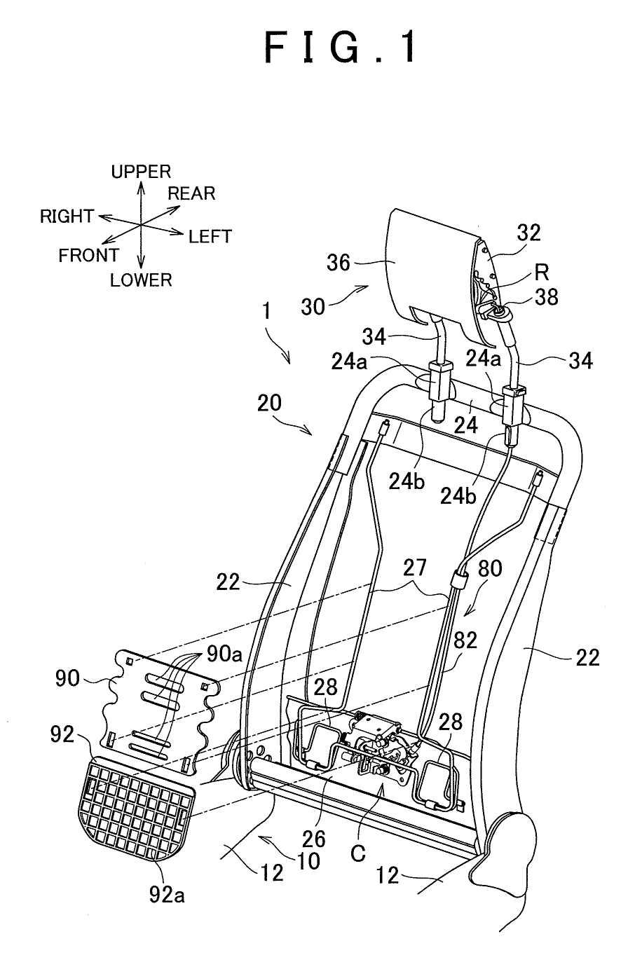

Embodiments of the present invention will be described below with reference to the drawings. A first embodiment is described with reference to FIG. 1 to FIG. 6. In FIG. 1, in order to clearly show the internal structure of a vehicle seat 1 that includes a seat cushion 10, a seatback 20, and an active headrest 30, cushion structures (e.g., a pad member of the seatback 20) and surface structures of these components are omitted, and only internal frame structures of these components are shown. In the following descriptions, the words “up”, “down”, “front”, “rear”, “left”, and “right” designate directions of “up”, “down”, “front”, “rear”, “left”, and “right” in the above drawings, or directions of “up”, “down”, “front”, “rear”, “left”, and “right” in terms of the vehicle seat 1 as a reference. The directions also apply to a second embodiment described later.

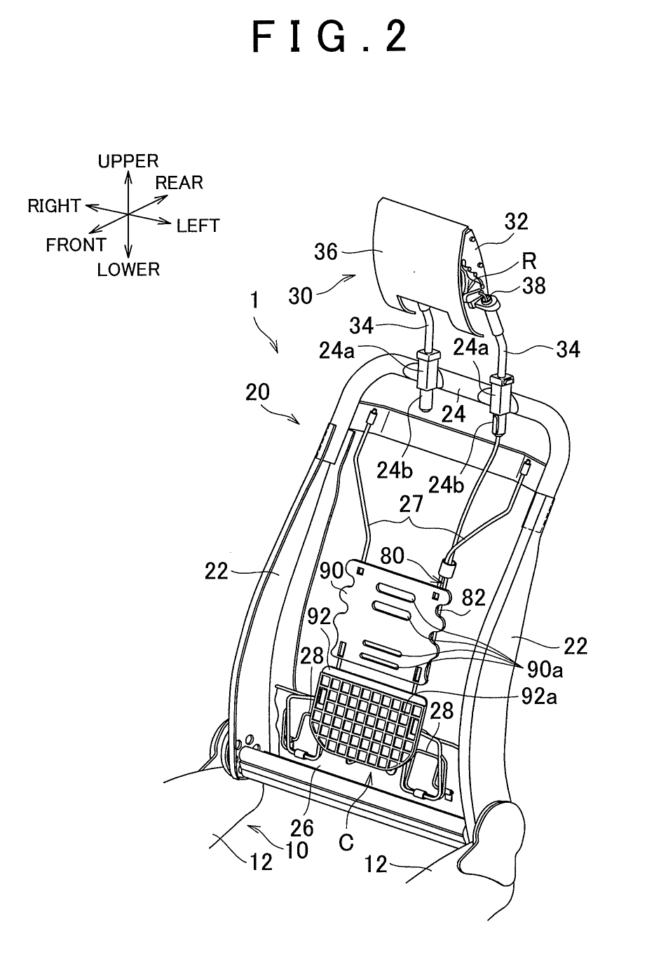

The overall configuration of the vehicle seat 1 according to the first embodiment will now be described. As shown in FIG. 1 and FIG. 2, the vehicle seat 1 includes: the seat cushion 10 on which an occupant sits, the seatback 20 as a backrest for the seated occupant, and the active headrest 30 that supports the back of the head of the seated occupant.

Of these components, the frame structures of the seatback 20 and the active headrest 30 will be described in detail. A detailed description of the seat cushion 10 is omitted since the seat cushion 10 adopts a conventional configuration. The frame structure of the seatback 20 will now be described in detail. The frame of the seatback 20 includes: right and left side frame members 22; an upper frame member 24 that is provided between the upper portions of the side frame members 22; and a lower frame member 26 that is provided between the lower portions of the side frame members 22.

The lower end of each side frame member 22 is attached to the rear end of a right and left cushion frame member 12, respectively, through a reclining mechanism (not shown). Accordingly, the seatback 20 may be tilted with respect to the seat cushion 10 and is retained in a desired tilt position within its tilt range.

A pair of holders 24a are attached to the upper frame member 24. Each holder 24a is assembled with a support 24b in which a stay 34 of a pair of stays of the active headrest 30 is inserted and locked. Accordingly, the active headrest 30 is connected to the seatback 20.

In one of the supports 24b (the left support 24b in FIG. 1), a rod-raising member (not shown) is provided to raise a rod 38 that is disposed in one of the stays 34 (the left stay 34 in FIG. 1) in order to unlock a lock mechanism R in the active headrest 30. The rod-raising member is connected to a second rocking member 75 through an operating cable 80. The operating cable 80 is a double-layered cable that includes an outer cable 82 and an inner cable 84 that can slide within the outer cable 82.

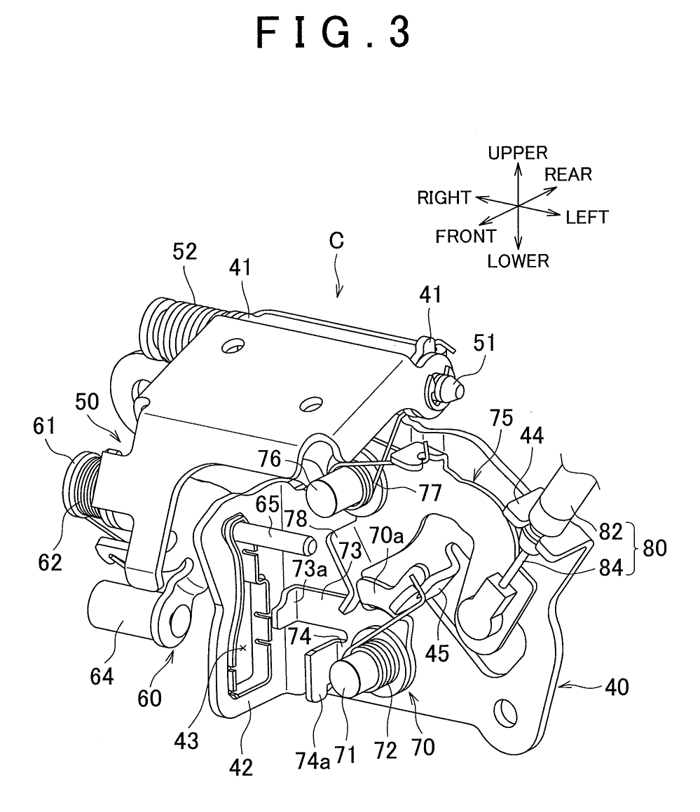

In the operating cable 80, the upper end of the outer cable 82 is retained by the rod raising member of the left support 24b, and the lower end of the outer cable 82 is retained by a third rib 44 of a base plate 40. Meanwhile, the upper end of the inner cable 84 is disposed in the rod raising member so that the inner cable 84 can raise the rod 38, and the lower end of the inner cable 84 is retained by the second rocking member 75 (see FIG. 3). The rod-raising member is configured to raise the rod 38 and unlock the lock mechanism R in the active headrest 30 when a tensile force acts on the inner cable 84. The frame of the seatback 20 is configured as described above.

Next, returning to FIG. 1, the frame structure of the active headrest 30 will be described in detail. The frame of the active headrest 30 includes: a base 32 that constitutes the contour of the active headrest 30; a pair of stays 34 that are integrally assembled with the base 32; and a support plate 36 that is attached to this base 32 through a tension spring and a link mechanism (neither of them is shown).

During a normal vehicle operation, the support plate 36 is locked by the lock mechanism R to be generally integrated with the base 32 against an urging force of the tension spring. However, when a rear-end collision occurs, the lock mechanism R is unlocked, the link mechanism is activated by the urging force of the tension spring. Consequently, the support plate 36 instantly moves forward with respect to the base 32. Therefore, it is possible to instantly receive the back of the head of the occupant with the support plate 36.

Next, a clutch mechanism C that is assembled to the seatback 20 will be described. As shown in FIG. 3 to FIG. 5, the clutch mechanism C includes the base plate 40, a pressure-receiving member 50, a coupling arm 60, a first rocking member 70, and the second rocking member 75. Each of these components 40, 50, 60, 70, and 75 will be described individually.

The base plate 40 will be described first. The base plate 40 constitutes the base of the clutch mechanism C. The base plate 40 is fastened to a front surface of the lower frame 26 (not shown in FIG. 3 to FIG. 5).

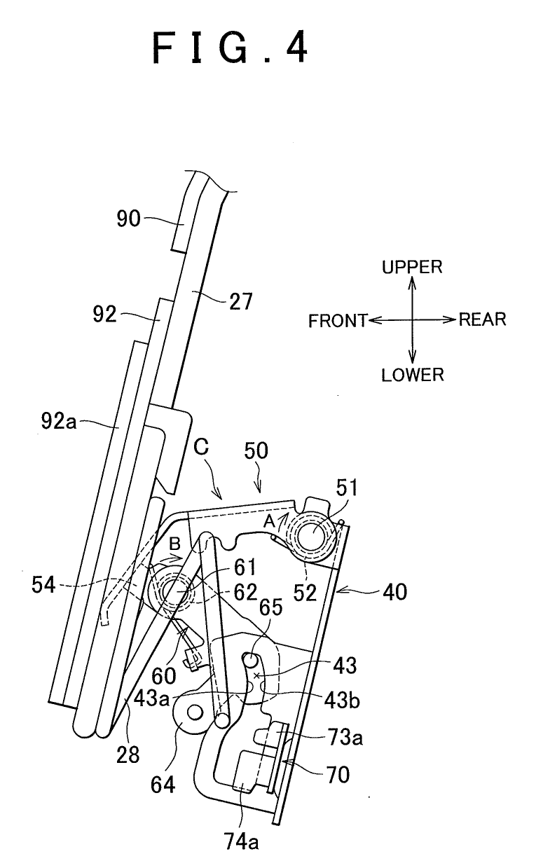

The pressure-receiving member 50 will be described next. The pressure-receiving member 50 is a plate that receives the load exerted from the lumbar region of the occupant among an entire load applied to the seatback by the occupant seated on the vehicle seat 1. The pressure-receiving member 50 is attached to a pair of first tabs 41, which are formed in the base plate 40, through a pin 51 so as to be turnable about an axis in a vehicle width direction. The pressure-receiving member 50 is attached to a torsion spring 52. The torsion spring 52 urges the pressure-receiving member 50 (in the arrow “A” direction in FIG. 4) so that a tip of the pressure-receiving member 50 contacts the back surface of a first seatback panel 90.

Next, the coupling arm 60 will be described. The coupling arm 60 is generally formed as an L-shaped member that transmits only the load exerted from the lumbar region of the occupant among the entire load applied to the seatback by the occupant in a rear-end collision to the first rocking member 70. At the bend in the L-shaped coupling arm 60, a pin 65 is provided to enable to move inside a slot 43 that is formed in a second tab 42 of the base plate 40. A weight 64 is attached to the tip of the coupling arm 60.

The base of this coupling arm 60 is attached to a tab 54, which is formed on the pressure-receiving member 50, through a pin 61 so as to be turnable about an axis in the vehicle width direction. The coupling arm 60 is attached to a torsion spring 62. The torsion spring 62 urges the pin 65 of the coupling arm 60 (in the arrow “B” direction in FIG. 4) so that the pin 65 contacts the front surface 43a of the slot 43.

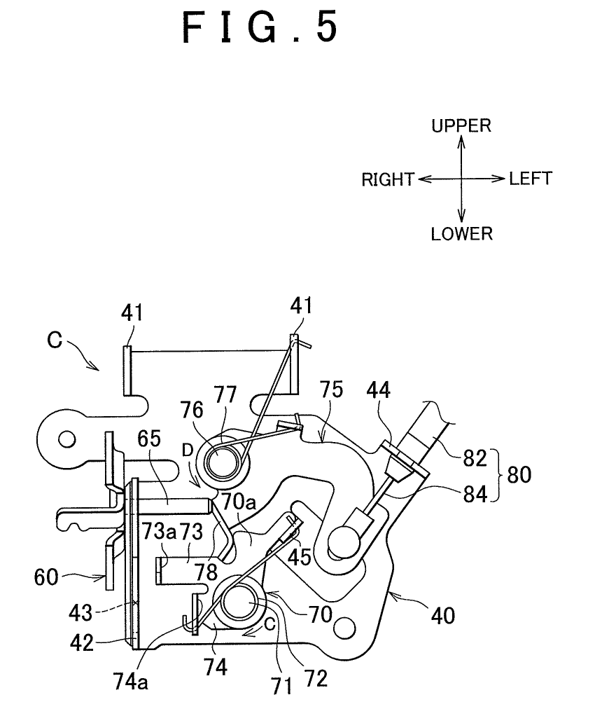

The first rocking member 70 will be described next. The first rocking member 70 is a plate that transmits the load applied to the seatback from the coupling arm 60 to the second rocking member 75. The first rocking member 70 is attached to the base plate 40 through a pin 71 so as to be turnable about an axis in a perpendicular direction to a surface of the base plate 40. The first rocking member 70 is attached to a torsion spring 72. The torsion spring 72 urges the first rocking member 70 so that a projecting portion 70a of the first rocking member 70 contacts a fourth tab 45 that is formed in the base plate 40 (in the arrow “C” direction in FIG. 5). The projecting portion 70a is formed to partially project from an outer periphery of the first rocking member 70.

The first rocking member 70 is formed with a first arm 73 and a second arm 74, each of which projects from a portion of the outer periphery of the first rocking member 70. Hooks 73a and 74a are formed at the tips of the arms 73 and 74, respectively. Of these hooks 73a and 74a, the hook 73a is formed such that the pin 65 of the coupling arm 60 presses against the hook 73a when the pin 65 is moved by a lesser load applied to the seatback, and the hook 74a is formed such that the pin 65 of the coupling arm 60 presses against the hook 74a when the pin 65 is moved by a greater load applied to the seatback.

Finally, the second rocking member 75 will be described. The second rocking member 75 is a plate that pulls the operating cable 80 using the load applied to the seatback that is transmitted from the first rocking member 70. In the same manner as the first rocking member 70, the second rocking member 75 is attached to the base plate 40 through a pin 76 so as to be turnable about an axis in a perpendicular direction to the surface of the base plate 40. The second rocking member 75 is attached to a torsion spring 77. The torsion spring 77 urges the second rocking member 75 so that a tab 78 of the second rocking member 75 contacts the projecting portion 70a of the first rocking member 70 (in the arrow “D” direction in FIG. 5). The tab 78 is formed on an outer peripheral surface of the second rocking member 75. As described above, the second rocking member 75 retains the lower end of the inner cable 84.

Next, the operation of the clutch mechanism C will be described. When the occupant leans against the seatback 20, the pressure-receiving member 50 receives the load exerted from the lumbar region of the occupant through a pad member (not shown) and a second seatback panel 92. Then, the coupling arm 60 turns such that the pin 65 moves downward in the slot 43 from a state shown in FIG. 4. Accordingly, the pin 65 of the coupling arm 60 moves along the front surface 43a of the slot 43 by the urging force of the torsion spring 62 that acts on the coupling arm 60.

When the occupant gets out of the vehicle (or when the occupant lies in the seatback 20), the pressure-receiving member 50 further receives the load exerted from the lumbar region of the occupant. Then, the coupling arm 60 turns such that the pin 65 thereof further moves downward in the slot 43 from the state shown in FIG. 4. Also, at this time, the pin 65 of the coupling arm 60 moves along the front surface 43a of the slot 43 by the urging force of the torsion spring 62 that acts on the coupling arm 60. Therefore, the load exerted from the lumbar region of the occupant by unloading of the occupant or by the occupant who leans against the seatback is not transmitted to the first rocking member 70. The same applies to the load exerted from the lumbar region of the occupant when the occupant gets in the vehicle.

If the vehicle is hit in a rear-end collision, the pressure-receiving member 50 receives the load exerted from the lumbar region of the occupant. Then, the coupling arm 60 turns such that the pin 65 moves downward in the slot 43 from the state shown in FIG. 4. Because an inertial force acts rearward on the weight 64 of the coupling arm 60 due to a rear-end collision of the vehicle, the pin 65 of the coupling arm 60 moves along a rear surface 43b of the slot 43 against the urging force of the torsion spring 62 that acts on the coupling arm 60.

Then, the pin 65 of the coupling arm 60 moves while pressing against the hook 73a of the first arm 73 in the first rocking member 70. Thus, with this movement, the pin 65 of the coupling arm 60 turns the first rocking member 70 against the urging force of the torsion spring 72. Therefore, the load exerted from the lumbar region of the occupant due to a rear-end collision of the vehicle is transmitted to the first rocking member 70.

At this time, the projecting portion 70a of the first rocking member 70 presses against the tab 78 of the second rocking member 75. Thus, along with this pressing, the second rocking member 75 also turns against the urging force of the torsion spring 77. Following the above, the inner cable 84 of the operating cable 80 is pulled, and thus a tensile force acts on the pulled inner cable 84. Thus, the lock mechanism R is unlocked and the support plate 36 moves forward toward the back of the head of the occupant. Therefore, it is possible to instantly receive the back of the head of the occupant with the support plate 36 immediately after the vehicle is hit in a rear-end collision.

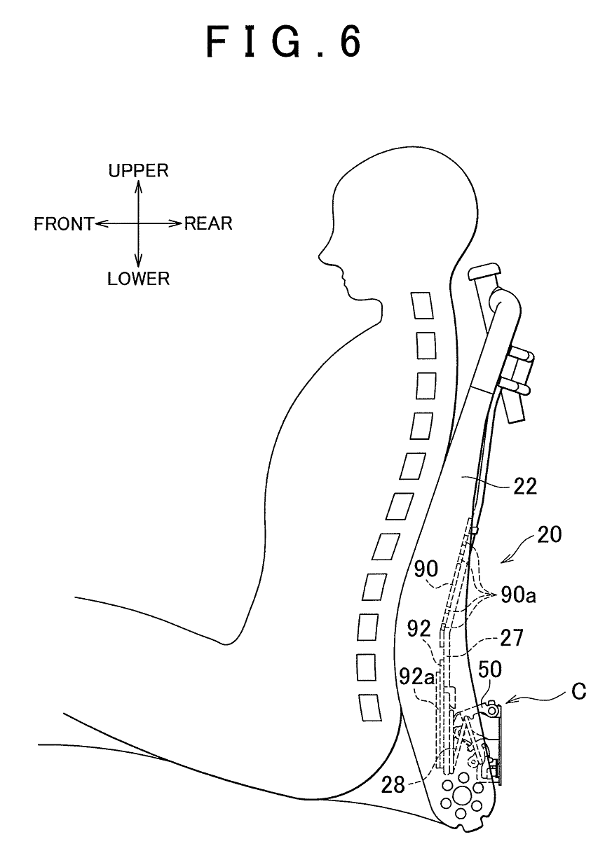

Next, referring to FIG. 2 and FIG. 6, the first panel 90 and the second panel 92 that are provided on a back surface side of the pad member (not shown), the pad member being attached to both of the side frames 22 of the seatback 20 so as to wrap around the side frames 22, will be described individually.

First, the first panel 90 will be described. The first panel 90 bridges a right and a left contour spring 27 that run along both of the side frames 22 and supports a portion of a rear side surface of the pad member of the seatback 20 that is located around the thoracic region of the occupant. A plurality (four in FIG. 2 and FIG. 4) of through holes 90a is formed in this first panel 90 in a manner to penetrate through the first panel 90 in a thickness direction.

Because each of the through holes 90a is formed to increase the flexibility of the first panel 90, the number and location of the through hole 90a is a design matter that may be appropriately decided in accordance with desired flexibility. By placing the first panel member 90 at the location on the seatback as described above, it is possible to receive the load exerted from the thoracic region of the occupant among the entire load applied by the occupant to the seatback. Forming the through holes 90a also improves the cushioning property of the seatback 20. It should be noted that this first panel 90 is integrally formed of resin.

The second panel 92 will now be described. The second panel 92 is attached the lower portions of the contour springs 27 and supports a portion of the rear surface side of the pad member of the seatback 20 that is located in the lumbar region of the occupant. In other words, the second panel 92 is attached to a curved fish-mouth spring 28 and is positioned in front of the pressure-receiving member 50 in the clutch mechanism C.

Of the entire load applied by the occupant to the seatback, it is possible to receive the load exerted from the lumbar region of the occupant by assembling the second panel 92 as described above. Then, it is possible for the received load applied to the seatback to turn the pressure-receiving member 50. The lower portion of each contour spring 27 is attached to the lower frame 26 through the curved spring 28. Accordingly, the lower portion of each of the contour springs 27 may be flexible in a longitudinal direction by flexibility that acts on the curved spring 28 in addition to the flexibility of its own. Therefore, it is possible to improve the cushioning property of the seatback 20.

In the second panel 92, a plurality of ribs 92a is formed in two directions (a vertical direction and a horizontal direction) on a front side surface of the second panel 92, that is, in a lattice shape. By forming the ribs 92a, the rigidity of the second panel member 92 can be enhanced. Because each of these ribs 92a is formed to provide rigidity to the second panel 92, the number and location of the rib 92a is merely a design matter that may be appropriately decided in accordance with desired rigidity. In the same manner as the first panel 90, the second panel 92 is integrally formed of resin.

The internal structure of the seatback 20 that includes the active headrest 30 according to the first embodiment of the present invention is configured as described above. According to the above configuration, because the first panel 90 is flexible, it is possible to flexibly support the thoracic region of the occupant. Therefore, it is possible to improve the riding comfort of the occupant. In addition, according to the above configuration, because the second panel 92 is rigid, it is possible to reliably turn the pressure-receiving member 50 using the load exerted from the lumbar region of the occupant. Therefore, the active headrest 30 is reliably activated.

According to this configuration, the first panel 90 and the second panel 92 are formed of resin. Therefore, it is possible to facilitate high-volume production of both of the panels 90 and 92.

According to this configuration, each of the first panel 90 and the second panel 92 is formed as a single-piece panel. Therefore, it is possible to facilitate the assembly of the panel members (the first panel member and the second panel member).

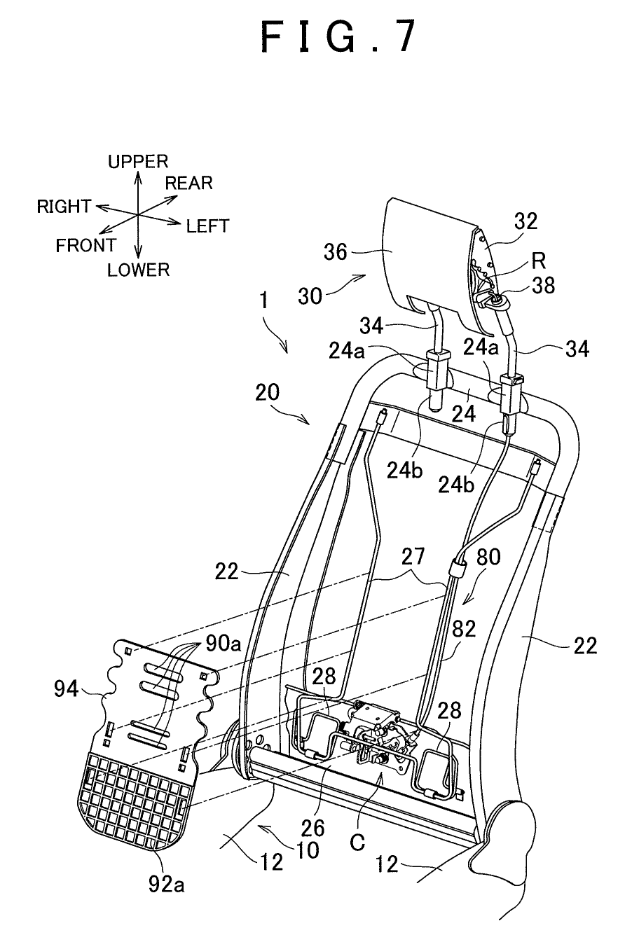

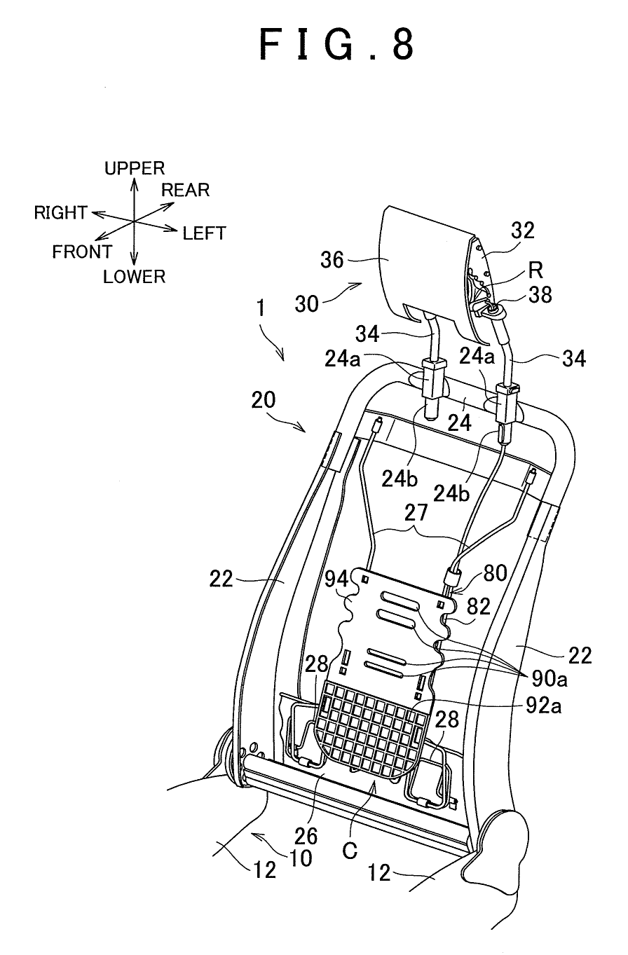

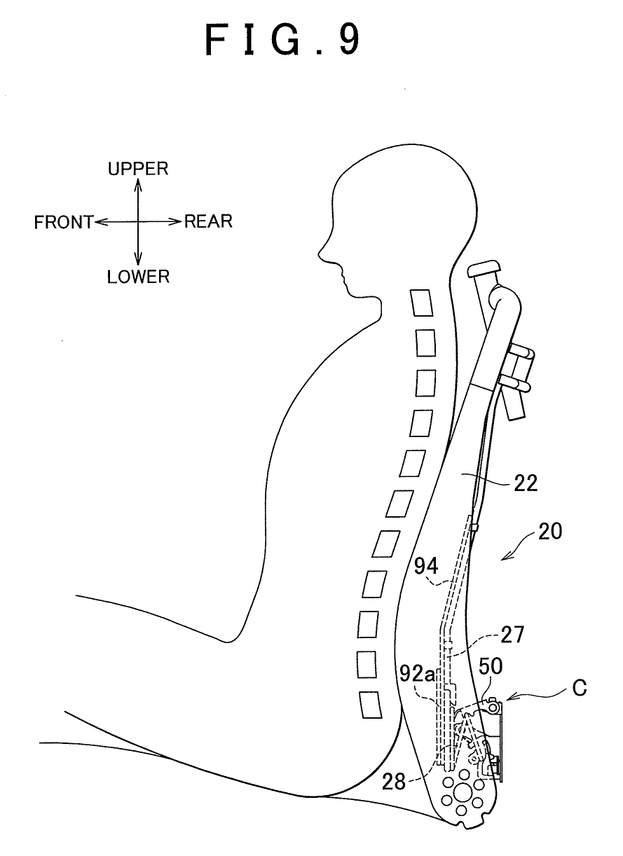

A second embodiment will next be described with reference to FIG. 7 to FIG. 9. Compared to the first embodiment, both of the panels 90 and 92 are integrally formed with each other in this second embodiment. That is, the first panel 90 and the second panel 92 are separately formed from each other in the first embodiment. In contrast, the first panel 90 and the second panel 92 are integrally formed with each other in the second embodiment, which will be described below. In the following description, same or like components as those in the first embodiment are denoted with the same reference numerals and symbols, and descriptions thereof will be omitted.

A panel 94 (in which the first panel 90 and the second panel 92 in the first embodiment are integrally formed) bridges the right and left contour springs 27 so as to generally support the entire rear surface side of the pad member of the seatback 20. Because the upper portion of the panel 94 is formed to correspond to the first panel 90 the through holes 90a are formed in the upper portion. Because the lower portion of the panel 94 is formed to correspond to the second panel 92, the ribs 92a are also formed in the lower portion. The panel 94 is also integrally formed of resin.

The internal structure of the seatback 20 that is assembled with the active headrest 30 according to the second embodiment of the present invention is configured as described above. Because this configuration includes the panel 94, in which the first panel 90 and the second panel 92 that have been described in the first embodiment are integrally formed with each other, it is possible to obtain the same operational effects as those in the first embodiment. In contrast to the first embodiment, only the single panel 94 needs to be attached in this configuration. Thus, it is possible to facilitate the assembly work. In the first embodiment, because two panels, specifically the first panel 90 and the second panel 92, need to be assembled into the left and right contour springs 27, the assembly process is more complex.

The above descriptions merely relate to embodiments of the present invention, and thus the present invention is not restricted to the above embodiments. In the first embodiment, a configuration in which the active headrest 30 moves forward to catch the back of the head of the occupant when load exerted from the lumbar region of the occupant to the seatback is received has been described. However, an alternative configuration may be adopted in which the active headrest 30 moves forward t catch the back of the head of the occupant when the load exerted from the thoracic region of the occupant is received. In this case, the pressure-receiving member 50 is reliably turned by the first panel 90 and that the riding comfort of the occupant is improved by the second panel 92. In other words, arrangements of both of the panels 90 and 92 are reversed from those in the first embodiment. These configurations also apply to the second embodiment.

In the first embodiment, the thoracic region of the occupant is flexibly supported by forming a through hole 90a in the first panel 90. However, the invention is not restricted to this configuration. For example, the thoracic region of the occupant may be flexibly supported either by forming a recessed hole in the first panel 90, by thinning the first panel 90, or by selecting a soft material for the first panel 90. Needless to say, it is possible to combine any of these configurations. The above configurations also apply to the second embodiment.

In the first embodiment, the rigidity of the second panel 92 is enhanced by forming the rib 92a in the second panel 92. However, the invention is not restricted to this configuration. For example, the rigidity of the second panel 92 may also be enhanced by either thickening the second panel 92 or selecting a hard material for the second panel 92. Needless to say, it is possible to combine any of these configurations. The above configurations also apply to the second embodiment. In the second embodiment, if separate materials are used for the upper half portion of the panel 94, which corresponds to the first panel 90, and the lower half portion of the panel 94, which corresponds to the second panel 92, two-color molding may also be employed, for example.

What is claimed is:

1. An internal structure of a seatback that includes an active headrest that moves forward to catch the back of an occupant's head when a load is applied by the occupant to a seatback in a rear-end collision, the internal structure comprising:
a first panel and a second panel that are provided between a plurality of frame members that constitute a frame of the seatback, wherein the first panel is flexible and the second panel is more rigid than the first panel; and
a pressure-receiving member that is attached to the second panel, receives the load applied to the seatback through the second panel, and transmits the applied load to a lock mechanism in the active headrest.

2. The internal structure of the seatback according to claim 1, wherein
the second panel is positioned near the lumbar region of the occupant, and
the first panel is arranged at a position above the second panel.

3. The internal structure of the seatback according to claim 2, wherein
the first panel and the second panel are provided between the frame members to support a rear surface of a pad member that is attached to the plurality of frame members.

4. The internal structure of the seatback according to claim 2, wherein
the first panel and the second panel are attached to a spring that is situated between the frame members.

5. The internal structure of the seatback according to claim 2, wherein
the first panel is made by forming at least one of a through hole in a thickness direction of the first panel and a recess in the thickness direction of the first panel.

6. The internal structure of the seatback according to claim 2, wherein
the second panel is made by forming a rib on a surface of the second panel.

7. The internal structure of the seatback according to claim 2, wherein
the first panel and the second panel are formed of resin.

8. The internal structure of the seatback according to claim 2, wherein
the first panel is integrally formed with the second panel.

9. The internal structure of the seatback according to claim 1, wherein
the first panel is positioned near the lumbar region of the occupant, and
the second panel is arranged at a position above the first panel.

10. The internal structure of the seatback according to claim 8, wherein
the first panel and the second panel are provided between the frame members to support a rear surface of a pad member that is attached to the plurality of frame members.

11. The internal structure of the seatback according to claim 8, wherein
the first panel and the second panel are attached to a spring that is provided between the frame members.

12. The internal structure of the seatback according to claim 8, wherein
the first panel is made by forming at least one of a through hole in a thickness direction of the first panel and a recess in the thickness direction of the first panel.

13. The internal structure of the seatback according to claim 8, wherein
the second panel is made by forming a rib on a surface of the second panel.

14. The internal structure of the seatback according to claim 8, wherein
the first panel and the second panel are formed of resin.

15. The internal structure of the seatback according to claim 8, wherein
the first panel is integrally formed with the second panel.
